(19) United States
(12) Patent Application Publication
(10) Pub. No.: US 2012/0091987 A1
(43) Pub. Date: Apr. 19, 2012

(54) SYSTEM FOR SUPPLYING ELECTRICAL ENERGY

(76) Inventors: Joerg Jehlicka, Rutesheim (DE); Roman Gronbach, Stuttgart (DE)

(21) Appl. No.: 13/262,461

(22) PCT Filed: Mar. 23, 2010
(86) PCT No.: PCT/EP10/53740

§ 371 Date: Jan. 4, 2012

(30) Foreign Application Priority Data
Mar. 31, 2009 (DE) 10 2009 002 006.3

(51) Int. Cl. G05F 3/02

(52) U.S. Cl. 323/311

(57) ABSTRACT

In a system for providing electrical energy for an electronic circuit adapted to supply power to a load, one terminal for a power supply voltage of the circuit is connected to a positive pole of an energy source, and one terminal for ground for the circuit is connected to a negative pole of the energy source via a rectifying electronic component, and a capacitor is connected between the two terminals of the circuit for partial supply of the circuit with electrical energy.

### FIELD OF THE INVENTION

The present invention relates to a system for supplying electrical energy for an electronic circuit and a method for supplying electrical energy.

### BACKGROUND INFORMATION

In motor vehicles, the terminal control relay, for example, relay KL15, is triggered for an output of an ignition switch, relay KL50 is triggered for a starter circuit and relay KL75 is triggered for the radio, normally via intelligent switches. These switches are designed either as low-side switches or as high-side switches, depending on the make and model of the vehicle. A trigger of the terminal control relays is usually supplied redundantly from two power supply voltage paths via a high-side switch. With such a design, the terminal control relay may also be operated even during a short-term voltage dip in a startup operation.

### SUMMARY

Example embodiments of the present invention provide a system for supplying electrical energy for an electronic circuit designed for supplying a load, a terminal for a power supply voltage of the circuit being connected or connectable to a positive pole of an energy source, and a terminal for ground of the circuit being connected or connectable to a negative pole of the energy source via an electronic component having a rectifying effect, which has a forward direction and a reverse direction, and a capacitor adapted for buffering is connectable between the two terminals of the circuit.

The electronic circuit, typically having at least one electronic module, may include a metal oxide semiconductor field effect transistor (MOSFET), which in this case is usually connected to the positive pole of the voltage source and may also be arranged as a high-side switch. Furthermore, the module may have a charge pump adapted for supplying electrical energy for the MOSFET, at least during normal operation of the module.

In addition, the electronic circuit may have a logic circuit, which is connected to the negative pole of the energy source. This system usually has a trigger circuit connected to the electronic circuit, including a driver having an open collector output. It is possible for the logic circuit of the electronic circuit to be connected to the trigger circuit.

In this system, a rectifying electronic component may be connected upstream from the negative pole of the energy source, which may be arranged as a voltage source, this latter component behaving like a diode and being arranged as a diode in example embodiments of the present invention. The rectifying component allows the current to pass through in only one direction (forward direction), but typically no flow is possible in the other direction (reverse direction). It is provided that the forward direction of the component having a rectifying effect is oriented toward the negative pole. This diode-like rectifying component, for example, an active diode, provides partial supply to the logic unit and the charge pump of the high-side switch.

In operation of the system having the diode-type component or the active diode and the capacitor designed for buffering, there is a shift in the voltage potential on the electronic circuit or the at least one module of the circuit when there is a dip in the starting voltage. The potential shift together with the diode-type component or the active diode causes only the logic unit and, if necessary, the charge pump of the module to be supplied with power in buffered form via the capacitor. The system thus temporarily has a low value for an undervoltage cutoff. The system having the circuit may also be operated even at a high voltage dip after a startup operation, the voltage optionally dropping to levels below the normal minimum voltage of the circuit.

The system described here is typically designed as a component of a control unit for a motor vehicle.

Example embodiments of the present invention provide a method for supplying electrical energy for an electronic circuit having at least one electronic module. The electronic circuit is adapted for supplying power, for example, for controlling another load, for example, a relay. A terminal arranged as a positive terminal for a supply voltage of the circuit is connected to a positive pole of an energy source, and a terminal of the circuit arranged as a ground terminal is connected to a negative pole of the energy source via a rectifying component having a positive direction and a reverse direction, for example, via a diode or active diode. Between the two terminals of the circuit a capacitor adapted for buffering is connected.

In example embodiments of the method, when a voltage dip occurs, a ground potential of the electronic module is shifted to a value of less than zero volt. With example embodiments of the present invention, a starting pulse for a fixed load triggering via a standard high-side switch, for example, the MOSFET as the module of the circuit, may be implemented. The capacitor is suitable for buffering electrical energy for a charge pump of the MOSFET and for the logic unit, which is usually also situated inside the circuit.

By using inexpensive standard modules, example embodiments of the present invention provide for a load to be supplied via a high-side switch if the starting voltage dips under elevated demands, for example, from a traditional battery voltage. The selected system or circuit is easily adaptable to strong starting dips in the voltage and is therefore robust.

The system described herein is adapted to perform all the steps of the aforementioned method. Individual steps of this method may also be performed by individual components of the system.

In addition, functions of the system or functions of individual components of the system may be implemented as steps of the method. Furthermore, it is possible that steps of the method may be implemented as functions of individual components of the system or of the entire system.

Additional advantages and aspects of example embodiments of the present invention are set forth in the following description and the accompanying drawings.

The features mentioned above and those yet to be discussed below may be used not only in the particular combination indicated but also in other combinations or alone.

### BRIEF DESCRIPTION OF THE DRAWINGS

FIG. 1 shows a diagram of a voltage curve obtained with one implementation of the method according to an example embodiment of the present invention.

FIG. 2 shows a schematic diagram of a conventional device.

FIG. 3 shows a schematic diagram of a system according to an example embodiment of the present invention.

### DETAILED DESCRIPTION

Example embodiments of the present invention are illustrated schematically in the drawings and are described in more detail below with reference to the drawings.

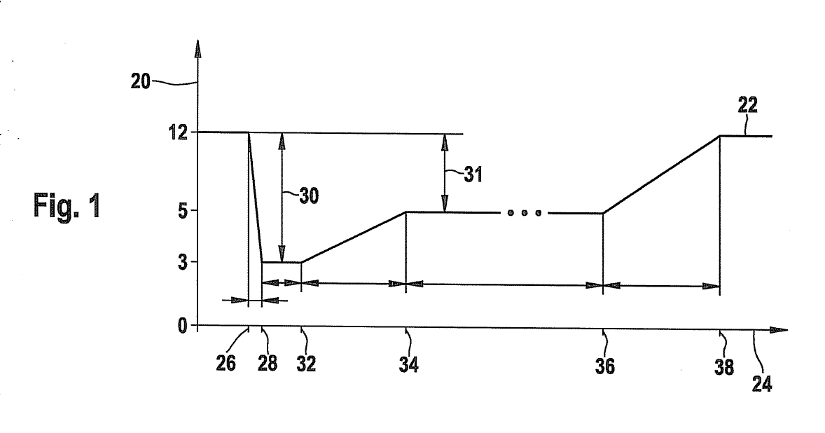

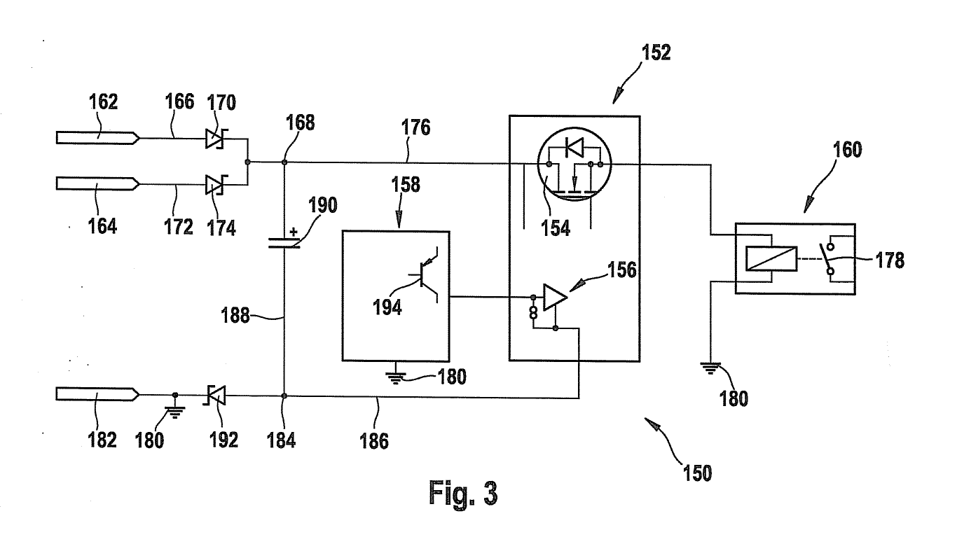

In the diagram from FIG. 1, a curve 22 for a voltage is plotted on a vertical axis 20 as a function of time, which is plotted on a horizontal axis 24. For curve 22 of the voltage, it is provided that the voltage is 12 volt up to a point in time t0 26 at which a device 50 described with reference to FIG. 1 or a system 150 according to an example embodiment of the present invention, which is described with reference to FIG. 3, is started. However, a starting voltage dip at which the voltage is reduced by a first voltage difference 30 of 9 volt occurs at a point in time t1 28 immediately after startup. The period of time between points in time t0 26 and t1 28 is usually less than 5 ms. For approximately 15 ms, the voltage remains at a level of 3 volt up to point in time t2 32 and then increases within a period of 50 ms to a level of 5 volt up to a point in time t3 34 so that a voltage difference 31 relative to the 12 volt battery voltage is 7 volt. As shown by curve 22, the voltage remains at the level of 5 volt for approximately 1 second up to point in time t4 36. Approximately 100 ms later, curve 22 of the voltage has reached a value of 12 volt for the starting voltage, i.e., the battery voltage up to point in time t5 38.

FIG. 1 thus shows the specification of a starting voltage dip under elevated demands. To ensure starting ability even with a cold and highly discharged battery, the terminal voltage should still be ensured even at a very strong starting voltage dip.

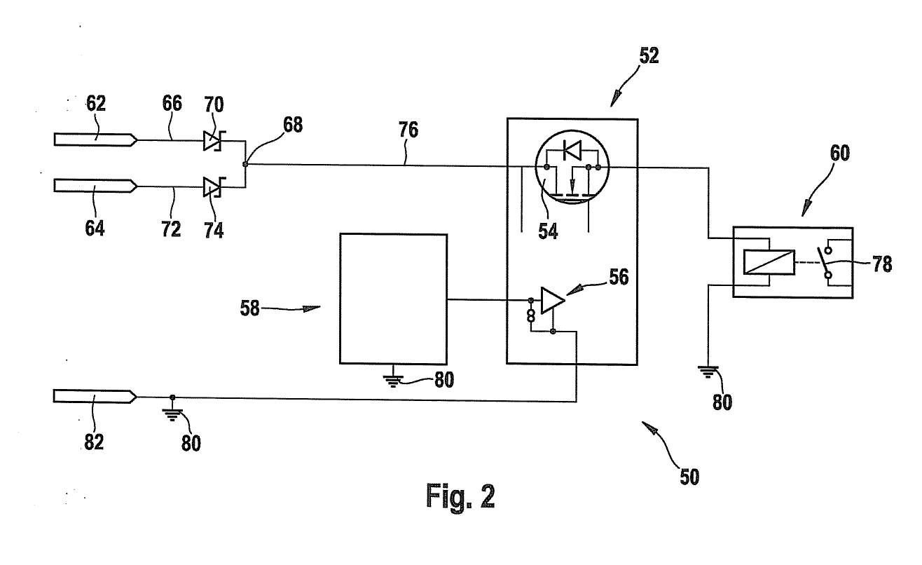

Device 50, which is diagramed schematically in FIG. 2 and is known from the related art, includes a circuit U1 52 having a MOSFET 54 and a logic circuit 56, a trigger circuit 58 and a relay 60 or a general load. One input of MOSFET 54 within circuit 52 is connected to a positive pole of an energy source via a first terminal “KL 30 L” 62 and a second terminal “KL 30 R” 64. A first diode D1 70 is situated along a first feeder line 66 between first terminal 62 and a node point 68. A second diode D2 74 is situated along a second feeder line 72 between second terminal 64 and node point 68. A positive feeder line 76 runs between node point 68 and the input of MOSFET 54. One output of MOSFET 54 is connected to relay 60 or to the general load, which includes a switch 78. In addition, one output of relay 60 or the general load is at ground 80. Furthermore, it is provided that logic circuit 56 of circuit 52 is connected to trigger circuit 58 and, via a third terminal “KL 31” 82, is connected to a negative pole of the energy source.

Device 50 shown in FIG. 2 does not meet the requirement of a very strong voltage dip according to FIG. 1. The low voltage in the range between points in time t1 28 and t3 34 is below the operating voltage of circuit U1 52. The operating voltage usable for circuit U1 52 is further reduced by the additional voltage drop across one of diodes D1 70 or D2 74. This low operating voltage is usually outside of the specified range of circuit U1 52 because a charge pump (not shown here) necessary for operation of MOSFET 54 is no longer functional.

The system 150 according to an example embodiment of the present invention diagramed schematically in FIG. 3, like the device 50 diagramed schematically in FIG. 2, includes a circuit U1 152, which has as a first component a MOSFET 154 to which a charge pump (not shown here) is assigned and has as a second component a logic circuit 156. Furthermore, system 150 has a trigger circuit 158 cooperating with circuit U1 152 and a load 160, arranged as a relay to be controlled with respect to a state via circuit U1 152. One input of circuit 152, corresponding here to an input of MOSFET 154, is redundantly connected to a positive pole of an energy source (not shown in FIG. 3) arranged as a battery via a first terminal “KL 30 L” 162 and via a second terminal “KL 30 R” 164.

A first diode D1 170 is situated along a first positive feeder line 166 of first terminal 162 up to a positive terminal 168. A second diode D2 174 is situated along a second positive feeder line 172 between second terminal 164 and positive terminal 168. Between positive terminal 168 and the input of circuit 152 and thus of MOSFET 154 there runs a third positive feeder line 176. Since MOSFET 154 is connected to the positive pole of the energy source, it is also referred to here as a so-called high-side switch. One output of MOSFET 154 is connected to general load 160. One output of general load 160 having a switch 178 is at ground 180. Logic circuit 156 of module 152 is connected, on the one hand, to trigger circuit 158 and, on the other hand, to a negative pole of the energy source via a third terminal “KL 31” 182.

In addition, the system 150 diagramed schematically in FIG. 3 has a connecting line 188 along which a capacitor 190 provided for buffering is situated, this connecting line being situated between positive terminal 168 and a ground terminal 184 situated along a negative feeder line 186 between logic circuit 156 and third terminal 182. In the example embodiment of system 150 shown, it is provided that a third diode D3 192 is situated as a rectifying electronic component having a forward direction and a reverse direction between third terminal 182 and negative terminal 184. Furthermore, trigger circuit 158 includes a driver 194, arranged as a transistor, having an open collector output.

The triggering of a consumer connected to circuit 152 D1, i.e., load 160 here, may be ensured even during the starting voltage dip depicted in FIG. 1 by the system shown in FIG. 3.

Low voltages on circuit 52 U1 within device 50 shown in FIG. 2 result in a failure of the charge pump and thus a failure of a switching function of circuit 52 U1.

To keep the charge pump active to supply MOSFET 154 within system 150 from FIG. 3 during the strong voltage dip, it may be provided that it is to be supplied with a sufficient voltage. In the circuit 152 arranged as an integrated high-side circuit, the charge pump is connected internally to the power supply of power MOSFET 154. To support the positive supply potential of the charge pump, thus very large capacitances would be necessary in conventional applications. To buffer only the lower operating current of the charge pump and not of the entire load circuit, the rectifying electronic component having one forward direction and one reverse direction and thus additional third diode D3 192 are inserted into the ground or GND terminal of circuit U1 152, and capacitor 190 is connected between positive terminal 168 (VBB) and the GND or ground terminal 184 of circuit U1 152. It is provided that the forward direction of third diode D3 192 is oriented as the rectifying component toward third terminal 182 and thus toward the negative pole.

Using this additional circuit including capacitor 190 and third diode D3 192 as a rectifying component, the power supply of logic circuit 156 in circuit U1 152 is adequately buffered via capacitor 190 to be supplied through capacitor C1 192 in the period of time between points in time t1 28 and t3 34. In the period of time between points in time t3 34 and t5 38, the power supply voltage is high enough to supply circuit U1 152 again directly via diodes D1 170, D2 174 and D3 192. The additional circuit results in the ground potential of circuit U1 152 shifting to less than 0 volt in a voltage dip. The resulting level offset in trigger circuit 158 may be compensated, for example, by using an open collector driver.

1-8. (canceled)

9. A system for providing electrical energy, comprising:
an electronic circuit adapted to supply power to a load;
wherein a terminal for a power supply voltage of the circuit is connectable to a positive pole of an energy source and a terminal for ground of the circuit is connectable to a negative pole of the energy source via a rectifying electronic component, and a capacitor adapted for partial supply of electrical energy to the circuit is connected between the two terminals.

10. The system according to claim 9, wherein the rectifying electronic component is arranged as a diode.

11. The system according to claim 9, wherein the electronic circuit includes a metal oxide semiconductor field effect transistor connected to the positive pole of the energy source.

12. The system according to claim 9, wherein the electronic circuit includes a logic circuit connected to the negative pole of the energy source.

13. The system according to claim 9, further comprising a trigger circuit connected to the electronic circuit, which includes a driver having an opened collector output.

14. The system according to claim 12, wherein the logic circuit is connected to a trigger circuit (158).

15. A method for supplying electrical energy for an electronic circuit adapted to supply power to a load, comprising:
connecting a terminal for a power supply voltage of the circuit to a positive pole of an energy source;
connecting a terminal for ground of the circuit to a negative pole of the energy source via a rectifying component; and
connecting a capacitor between the two terminals of the circuit.

16. The method according to claim 15, further comprising shifting a ground potential of the electronic circuit to a value of less than zero volt on occurrence of a voltage dip.

17. A system for providing electrical energy, comprising:
an electronic circuit adapted to supply power to a load;
wherein a terminal for a power supply voltage of the circuit is connected to a positive pole of an energy source and a terminal for ground of the circuit is connected to a negative pole of the energy source via a rectifying electronic component, and a capacitor adapted for partial supply of electrical energy to the circuit is connected between the two terminals.
